(19) United States
(12) Patent Application Publication
(10) Pub. No.: US 2010/0107415 A1
(43) Pub. Date: May 6, 2010

(54) Combo disposable razor and shaving lubricant dispenser

(76) Inventor: Steven M. Kurzet, Southern Pines, NC (US)

Correspondence Address: LITMAN LAW OFFICES, LTD., POST OFFICE BOX 41200, SOUTH STATION, ARLINGTON, VA, 22204, US

(21) Appl. No.: 12/320,737

(22) Filed: Feb. 3, 2009

Related U.S. Application Data
(60) Provisional application No. 61/193,159, filed on Oct. 31, 2008.

(51) Int. Cl. B26B 19/38

(52) U.S. Cl. 30/41

(57) ABSTRACT

The combo disposable razor and shaving lubricant dispenser includes an elongated handle defining a cavity holding shaving lubricant. The handle defines a slider track and an opening for dispensing the shaving lubricant from the cavity. A pusher is movably positioned in the cavity and pushes the shaving lubricant out the opening. A slider is connected to the pusher and is positioned over the slider track and outside the cavity. In one embodiment, a permeable bladder holds the shaving lubricant and is positioned in the cavity. A second embodiment has sealing material covering the slider track in order to keep the shaving lubricant fresh. A third embodiment has two tubular cavities, two slider tracks, and two pushers that are individually movably in each of the cavities by a slider connected to each of the pushers. Two straw-shaped tubes hold the shaving lubricant and are positioned in each of the cavities.

### CROSS-REFERENCE TO RELATED APPLICATION

This application claims the benefit of U.S. Provisional Patent Application Ser. No. 61/193,159, filed Oct. 31, 2008.

### BACKGROUND OF THE INVENTION

1. Field of the Invention

The present invention relates generally to disposable shaving implements and shaving lubricants, and, in particular, to a combo disposable razor and shaving lubricant dispenser.

2. Description of the Related Art

With a conventional disposable hand razor, a razor blade is mounted in a shaving head portion of the hand razor that is carried on an end of a handle, with the handle being grasped by the shaver during shaving. During the shaving operation, the shaver conventionally applies lather-forming shaving lubricant to a body portion, such as the face, to be shaved. The lathers, creams, gels and the like, are applied to the face or body portions, and are typically supplied in large, relatively heavy multiple serving plastic and/or metallic containers. These large containers are okay for home use.

But when traveling or otherwise away from home, it is often desirable to shave before an important meeting or social occasion. It is inconvenient for most individuals to carry a separate shaver and shaving cream dispenser both before and after use. In addition, it is often impossible to anticipate that such items will be necessary when leaving the home or office. Furthermore, no one likes to carry excess weight on a trip. The cans are bulky and difficult to store, especially where luggage space is limited. Cans and lotion bottles can leak in the luggage, especially at low pressure in airplane baggage compartments. Thus, it makes little sense to carry the razor, and shaving lubricant can on an overnight or 2-day trip.

A number of disposable type razors that include a supply of shaving lubricant in the handle have been developed. But these razors suffer from several drawbacks. For example, some razors do not provide enough lather, the reservoir having been overly used. Some razors are not in an airtight seal causing the shaving lubricant to dry out prior to use. Other types require the handle to be flexible in order to squeeze out the shaving material. These disposable razors have the shaving lubricant exiting out the butt of the handle. This results in a dangerous situation because the razor gets touched and, usually, the shaver's hand is cut. Some disposable razors have the shaving lubricant exiting from the razor head. The problem with these is that, when shaving lubricant is being applied to the face, the razor can cut the face, due to the manipulation of the razor. Still, other disposable razors are so complex with a piston-type of device forcing out the lubricant that they are easily damaged when dropped. Additionally, many of these available disposable razors require the shaver to “re-learn” how to shave when applying the shaving lubricant or favor the right hand over the left or vice versa.

Thus, a combo disposable razor and shaving lubricant dispenser solving the aforementioned problems is desired.

### SUMMARY OF THE INVENTION

The combo disposable razor and shaving lubricant dispenser includes an elongated rectangular handle defining a cavity holding shaving lubricant. The handle has a butt end and a razor head. The razor head securely holds at least one razor and has an arcuate wall. The elongated rectangular handle has a top side and a bottom side. The cavity extends from nearly the butt end to the arcuate wall. The topside has an open slider track exposing the cavity, and the bottom side has an opening near the arcuate wall for dispensing the shaving lubricant from the cavity. A cube-shaped pusher is movably positioned in the cavity. The pusher is for pushing the shaving lubricant from the cavity, out the opening and through the bottom side of the body. A slider is connected to the pusher and positioned on the top side of the elongated rectangular handle over the slider track and outside the cavity. The slider is for moving the pusher in a direction from the butt end towards the arcuate wall.

A ball is movably positioned in the cavity between the pusher and the arcuate wall. The ball is for moving the shaving lubricant from the cavity out the opening in the bottom side. The arcuate wall guides the ball into the opening in the bottom side of the elongated rectangular body. A tab member is attached to the opening in the bottom side of the elongated rectangular handle. The tab member is removed prior to movement of the slider for exposing the opening in the bottom side during the dispensing of the shaving lubricant.

One embodiment includes a permeable bladder that holds the shaving lubricant. The bladder is positioned in the cavity of the elongated rectangular body. In another embodiment, the combo disposable razor and shaving lubricant dispenser has a sealing material that covers the slider track in order to keep the shaving lubricant fresh. The sealing material is removed prior to moving the slider towards the arcuate wall of the second solid section.

A still further embodiment of the combo disposable razor and shaving lubricant dispenser includes an elongated hexagonal handle that defines two tubular cavities. Each of the cavities is adapted for holding shaving lubricant. The handle has a hexagonal butt end and a razor head. The razor head has a solid portion, and the handle has six sides, including a topside and a bottom side. The two tubular cavities extend from the butt end to the solid portion. Two of the sides next to the topside have a slider track, and two of the other sides next to the bottom side have an opening near the solid portion. The openings are adapted for dispensing the shaving lubricant from either one of the cavities.

The combo disposable razor and shaving lubricant dispenser of this embodiment has two pushers, each cavity having one of the pushers slidably disposed therein. Each pusher is independently operable to push the shaving lubricant from its corresponding cavity through one of the openings in the side next to the bottom side. Each pusher has a slider connected thereto. The sliders are positioned on one of the sides next to the top side of the handle over the respective slider track and outside the respective cavity. The sliders move the corresponding pusher from the butt end towards the solid portion to eject shaving lubricant from the cavity. The dispenser has a tab member releasably covering each opening on the side next to the bottom side of the handle. Each tab member is removed to permit dispensing shaving lubricant from the corresponding cavity.

In this embodiment, the dispenser has two permeable straw-shaped bladders. Each of the straw shaped bladders is adapted for holding the shaving lubricant and is positioned in each of the handle cavities. Each of the pushers has an arcuate wedge-shaped member for pushing on the respective bladder to force the shaving lubricant towards the solid portion and out the respective opening. Each of the straw-shaped bladders has a flexible end having a slightly smaller diameter than the diameter of the openings to form a friction fit securing the flexible end of the bladder into the respective opening. The other end has a flexible, semi-conical shape forming a ramp-like member to facilitate movement of the corresponding pusher.

These and other features of the present invention will become readily apparent upon further review of the following specification and drawings.

### BRIEF DESCRIPTION OF THE DRAWINGS

FIG. 1 is a perspective view of a first embodiment of a combo disposable razor and shaving lubricant dispenser according to the present invention.

FIG. 2 is a perspective view of a second embodiment of a combo disposable razor and shaving lubricant dispenser according to the present invention.

FIG. 3 is a section view taken along lines 3-3 of FIG. 1.

FIG. 4 is a section view taken along lines 4-4 of FIG. 2.

FIG. 5 is a perspective view of a third embodiment of a combo disposable razor and shaving lubricant dispenser according to the present invention.

FIG. 6 is an exploded view of the combo disposable razor and shaving lubricant dispenser of FIG. 5.

FIG. 7 is a top view of the combo disposable razor and shaving lubricant dispenser of FIG. 5.

FIG. 8 is a side view of the combo disposable razor and shaving lubricant dispenser of FIG. 5.

FIG. 9 is a bottom view of the combo disposable razor and shaving lubricant dispenser of FIG. 5.

Similar reference characters denote corresponding features consistently throughout the attached drawings.

### DETAILED DESCRIPTION OF THE PREFERRED EMBODIMENTS

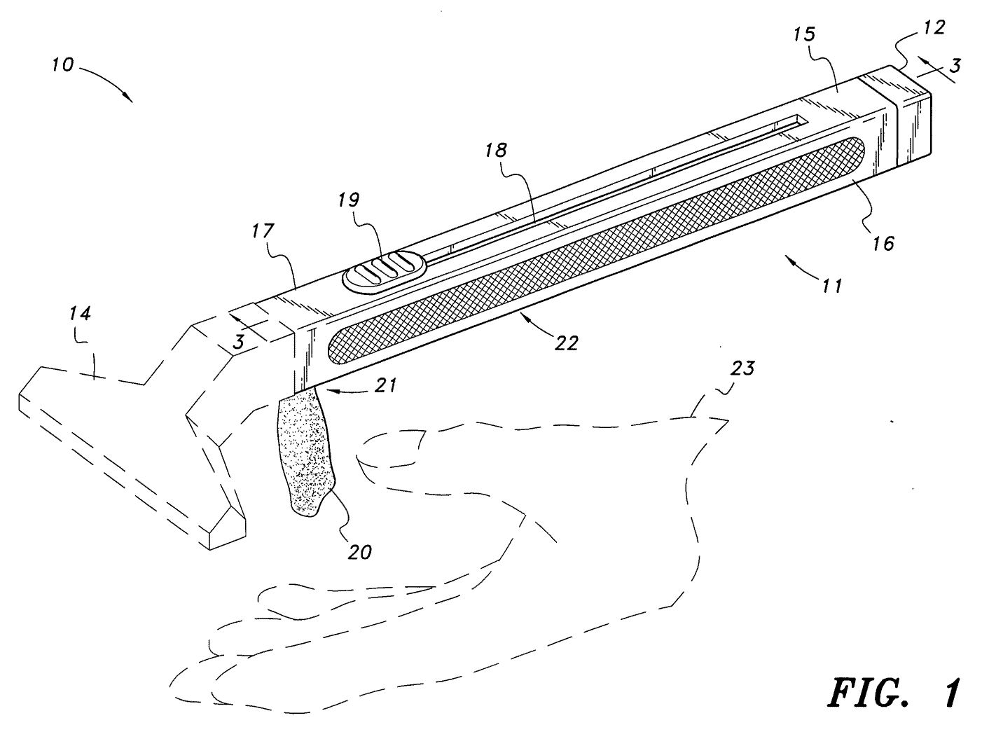

The present invention, as shown in FIG. 1, is a combo disposable razor and shaving lubricant dispenser that is generally indicated by number 10. The combo disposable razor and shaving lubricant dispenser 10 includes an elongated rectangular handle 11. The handle 11 has two ends, a butt end 12 and a razor head 14. The butt end 12 is securely attached to a first solid section 15 of the handle 11. This first solid section 15 serves to provide weight to the combo disposable razor and shaving lubricant dispenser 10, as well as support during use. The razor head 14 securely holds at least one razor blade. As is common, disposable shavers have a razor blade or steel cutting edge. To achieve higher shaving efficiency, disposable shavers may have one, two or more inline cutting edges. Thus, the number of razor blades in the razor head 14 can be one or more.

The handle 11 has an elongated rectangular body 16. The body 16 has a topside 17. The topside 17 has an open slider track 18 that permits movement of a slider 19 from the butt end 12 toward the razor head 14. This movement dispenses shaving lubricant 20 through a dispensing hole 21 located on the bottom side 22 of the body 16. The bottom side 22 is 180° opposite the topside 17, the slider track 18 and the slider 19 being located on the bottom side 22. The shaving lubricant 20 may be any type of shaving lubricant, such as, but not limited to, shaving creams, lathers, foams or gels. The shaving lubricant 20 is dispensed into a free hand 23 of the shaver. From there, the shaving lubricant 20 is applied to an area to be shaved in a manner consistent with how one would apply similar shaving lubricant.

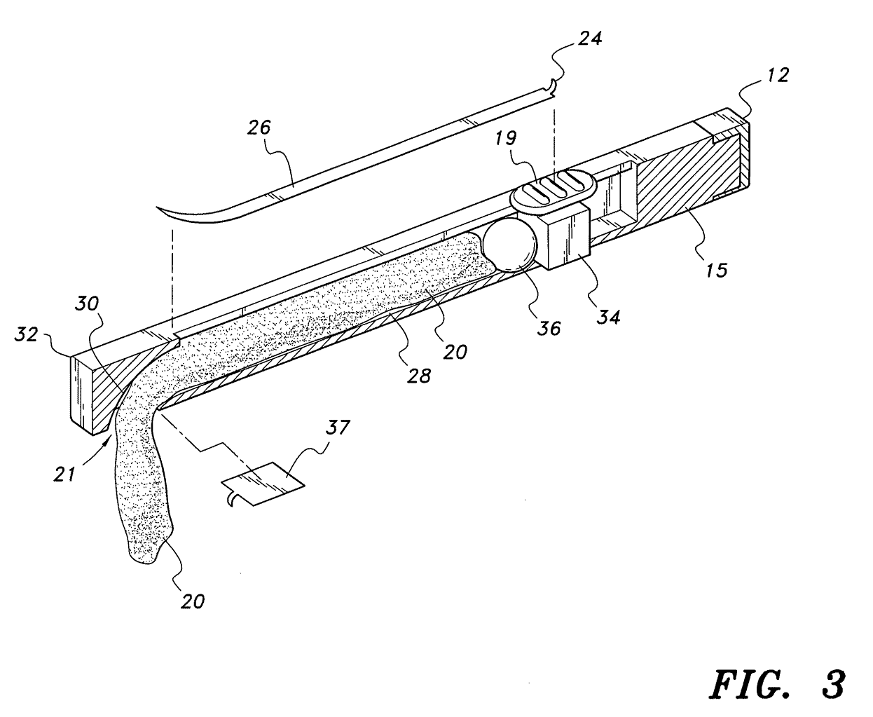

With reference to FIGS. 1 and 3, a first embodiment of the combo disposable razor and shaving lubricant dispenser 10 is described. Along the slider track 19 is a pull tab 24 that is attached to a sealing sheet of plastic 26 or some similar airtight material. The body 16 of the handle 11 includes a cavity 28. The cavity 28 holds or stores the shaving lubricant 20 prior to the shaving lubricant 20 being dispensed through the dispensing hole 21 and the hand 23. The cavity 28 extends from nearly the first solid section 15 to an arcuate wall 30 of a second solid section 32 that is securely attached to the razor head 14. The pull tab 24 and sealer sheet 26 are affixed to the slider track 18 creating an airtight or quasi-airtight seal that protects the integrity of the shaving lubricant 20 until pulled off. Pulling the tab 24 reveals the slider track 18 and allows the slider 19 to travel along the track 18, thereby dispensing the shaving lubricant 20 through the dispensing hole 21. Thus, the bottom side 22 has the dispensing hole or opening 21 near the arcuate wall 30 of the second solid section 32 for dispensing the shaving lubricant 20 from the cavity 28.

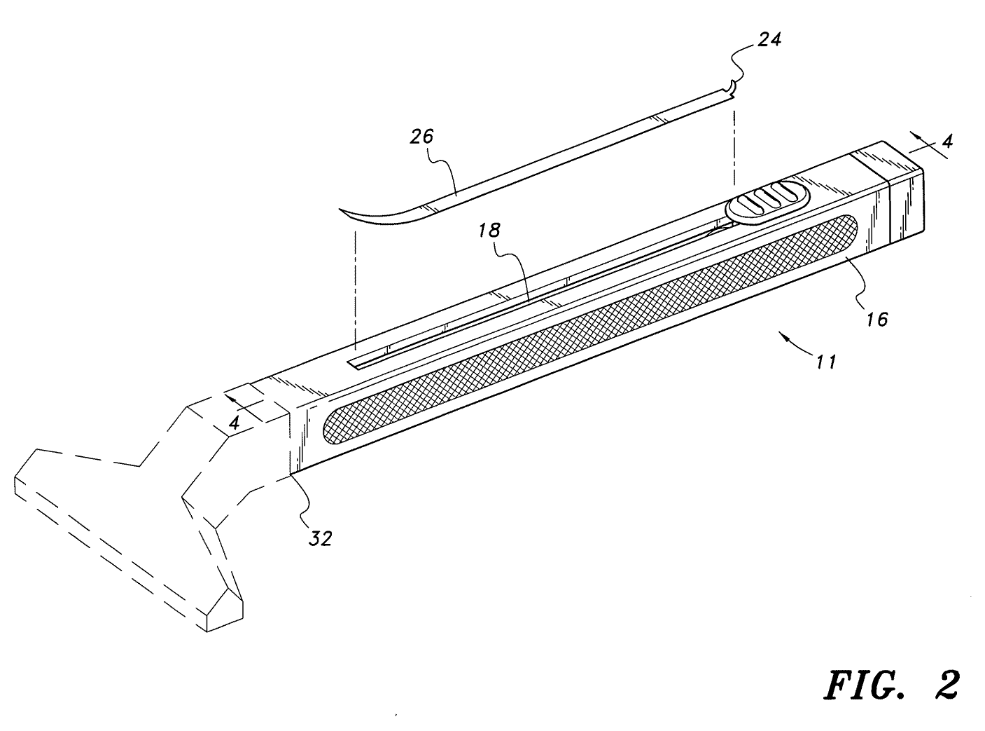

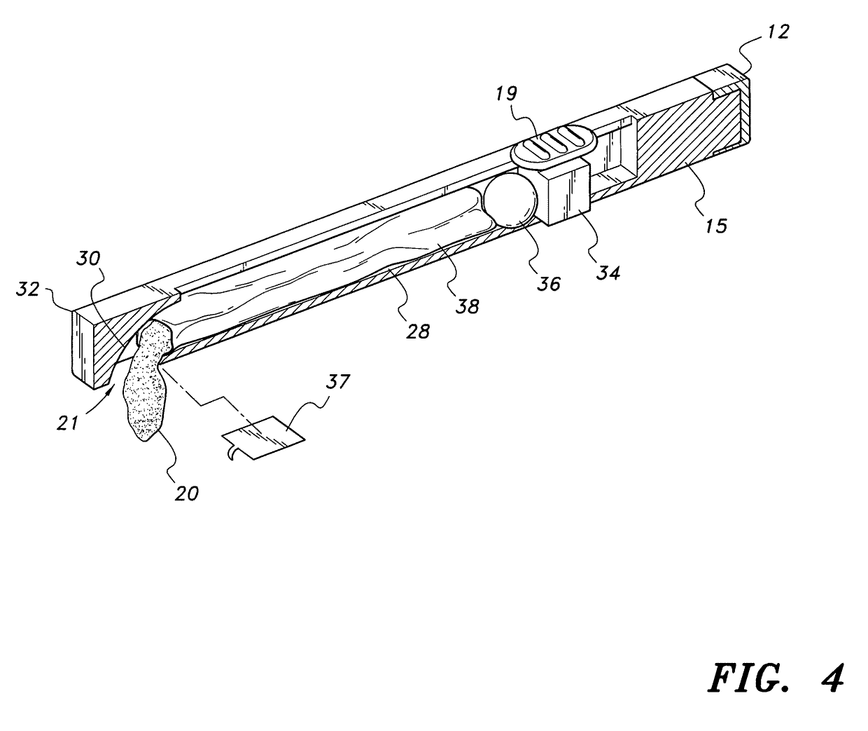

As shown in FIG. 3 and also in a second embodiment shown in FIGS. 2 and 4, a cube-shaped pusher 34 is movably positioned in the cavity 28 for pushing the shaving lubricant 20 from the cavity 28 out the opening 21 in the bottom side 22. The pusher 34 is securely connected to the slider 19 that is positioned on the topside 17 of the elongated rectangular body 16 over the slider track 18 and outside the cavity 28. The slider 19 moves the pusher 34 in a direction from the first solid section 15 towards the arcuate wall 30 of the second solid section 32. A ball 36 is movably positioned in the cavity 28 between the pusher 34 and the arcuate wall 30 of the second solid section 32. The ball 36 moves and rotates in tandem with the pusher 34 and the slider 19.

The pusher 34 is of a height and width equal to that of the inside dimensions of the cavity 28 so that edges of the pusher 34 act as scraping devices to collect shaving lubricant 20 that gets pushed aside by the ball 36 in the sliding process. Also, the ball 36 that is positioned at a center point of the pushing block 34 has a radius equal to one-half the width of the pusher 34. In either the first or second embodiments, shown FIGS. 3 and 4, the ball 36 pushes the shaving lubricant 20 through the cavity 28, and the remnant lubricant is collected by the edges of the pusher 34. The shaving lubricant 20 is thus pushed through the cavity 28 towards the dispensing hole 21. The arcuate dispensing wall 30 is the offset image of one-quarter dimension of the ball 36, so that the shape of the arcuate wall 30 will seed into the ball 36 and the ball 36 will have a final resting place, when the slider 19 has been fully deployed, abutting the arcuate wall 30 and covering the dispensing hole 21.

A tab member 37 is attached to the dispensing hole or opening 21 in the bottom side 22 of the elongated rectangular body 16 for removal prior to the movement of the slider 19 to expose the opening 21 in the bottom side 22 of the elongated rectangular body 19 for the dispensing of the shaving lubricant 20.

In the first embodiment shown in FIG. 3, to prevent the shaving lubricant 20 from oozing out the top of the slider track 18, the slider track 18 can have a very narrow bead separating the top of the pusher 34 and the slider 19. The shaving lubricant 20 is not loaded under pressure, so one would have to turn the combo disposable razor and dispenser 10 upside down to get the shaving lubricant 20 to ooze out the slider track 18.

Alternatively, should the slider track 18 be too wide and allow shaving lubricant 20 to ooze or seep, the slider track 18 can be sealed in the cavity 28 just to the front of the pusher 34 and the slider 19 with the same sealing material as the sealing sheet of plastic 26. Thus, the connection between the slider 19 and the pusher 34 would cut through the material, which would keep the lubricant 20 from dispensing through the slider track 18.

The second embodiment, shown in FIG. 4, augments cavity 28 with the malleable bladder 38 being sufficient to keep the shaving material enclosed, but of a nature that will allow the bladder 38 to puncture when the pusher 34 and ball 36 move the bladder 38 over toward the dispensing hole 21 after the tab 37 is removed.

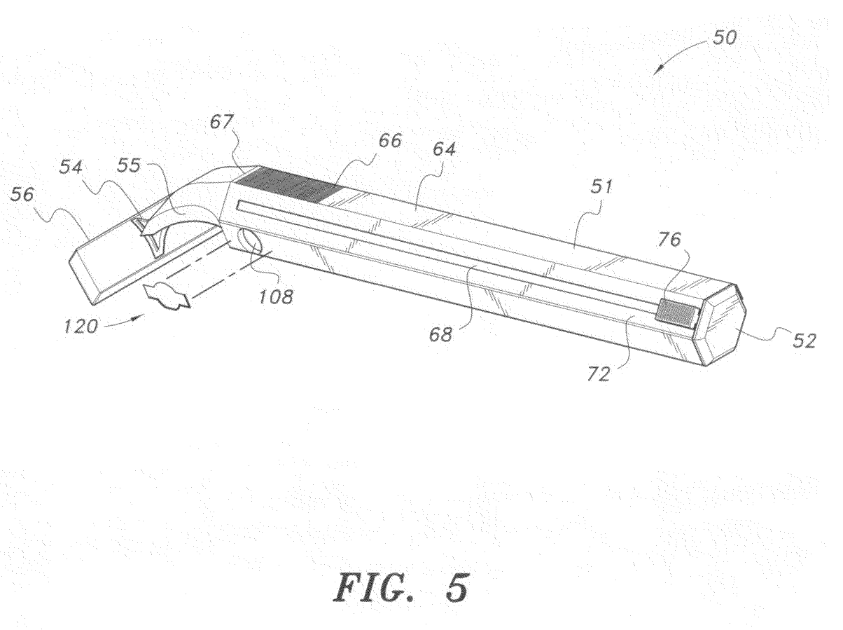

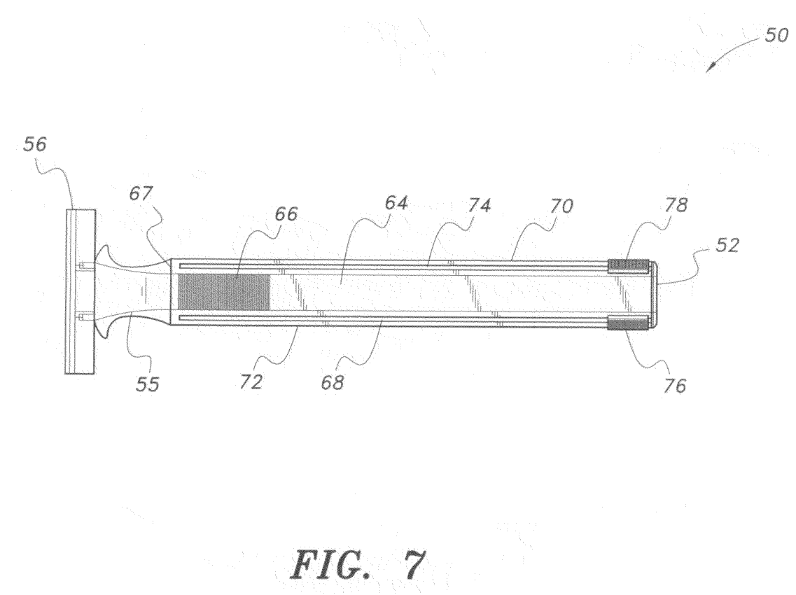

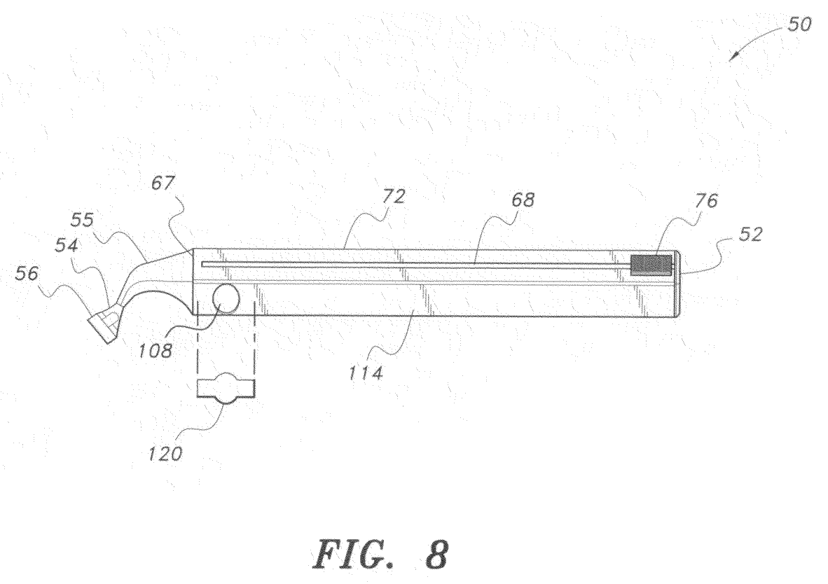

A third embodiment of the combo disposable razor and shaving lubricant dispenser is shown in FIGS. 5-9. This embodiment of the combo disposable razor and shaving lubricant dispenser is somewhat different than the first and second embodiments, and is thus indicated by the number 50.

The combo disposable razor and shaving lubricant dispenser 50 has an elongated, six-sided polygonal or hexagonal handle or body 51. The handle 51 has two ends, a butt end having end cap 52 and a swivel razor head mount 54. A solid, arcuate neck 55 joins the swivel razor head mount 54 to the body 51, and a razor head 56 is removably attached to the head mount 54. The neck 55 serves to provide weight to the combo disposable razor and shaving lubricant dispenser 50, as well as support during use. The cartridge 56 securely holds at least one razor blade. The head 56 is removable so that the head 56 can be readily replaced when the blade(s) is dull. As is common, disposable shavers have a razor blade or steel cutting edge. To achieve higher shaving efficiency, disposable shavers may have one, two or more inline cutting edges. Thus, the number of razor blades in the razor head 56 can be one or more.

The end cap 52 at the butt end is hexagonal and, in the preferred embodiment, is securely attached to the hexagonal body or handle 51 by fusing or by pressure fit. The end cap 52 can also be removable, using a snap-type fitting or hinge-type fitting in order to detach it and access an inner portion 58 of the handle 51.

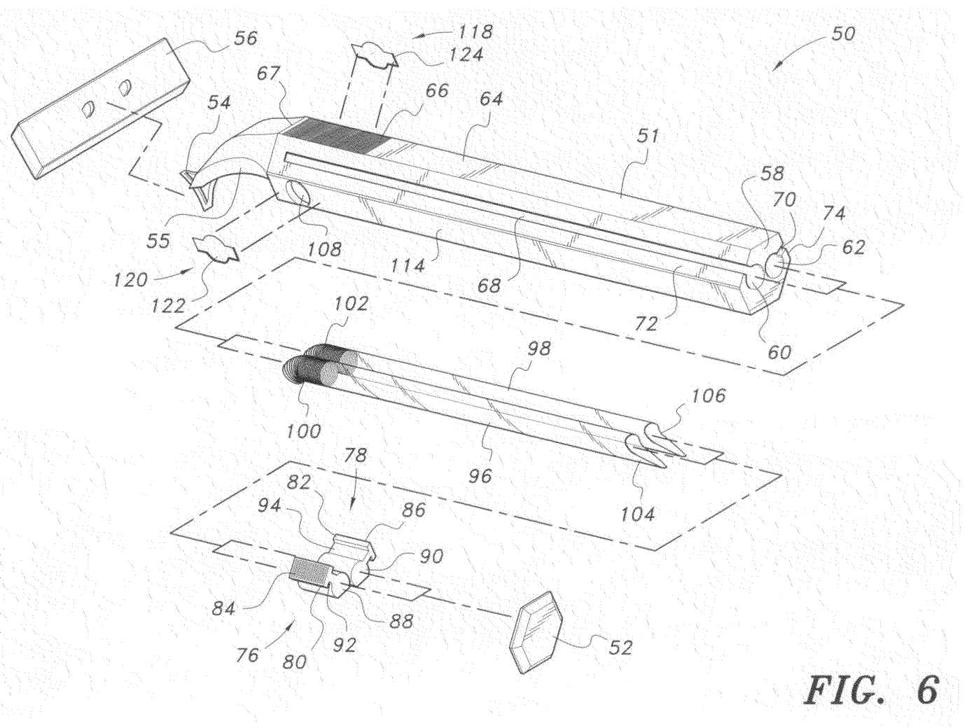

As shown in FIG. 6, the inner, solid portion 58 of the body 51 has two elongated, parallel cavities, bores, or channels 60, 62 that open at the butt end of the body 51. The body 51 has an elongated rectangular top face 64 that extends from the butt end to the neck 55. Near the neck 55 on the top face 64 is a non-slip ridged or knurled portion 66. The non-slip portion 66 provides a bearing surface for a finger of the user to support the combo disposable razor and shaving lubricant dispenser 50 when shaving or removing the head 56. The non-slip portion 66 can be either a separate component attached to the topside 64, or merely a number of grooves or diagonal patterns cut into or extending away from the topside 64. In either case, the non-slip portion 66 has ridges that protrude from the topside 64. It is also contemplated that a joint 67 is formed adjacent the non-skip portion 66 at the junction of the body 51 and the neck 55. The joint 67 may be fused so that the neck 55 is solidly and securely connected to the handle body 51, or may be hinged to permit access into the cavities 60, 62.

Two open slider tracks 68, 70 are cut into the cavities 60, 62 along the faces 72, 74 that extend from opposite sides of the top face 64 of the hexagonal body 51. The slider tracks 68, 70 are slit-like openings and extend nearly the entire length of the respective hexagonal faces 72, 74. The slider tracks 68, 70 guide sliders 76, 78. The slider tracks 68, 70 permit independent movement of the sliders 76, 78 from the butt end of the body 51 towards the neck 55.

As shown in FIG. 6, the sliders 76, 78 are distinctly different than the ball 36 and cube-shaped pusher 34 of the first two embodiments. Each of the sliders 76, 78 has a rectangular finger tab 80, 82. The finger tabs 80, 82 have ridged faces 84, 86 that provide a frictional bearing surface for the user's finger to individually push the sliders 76, 78 away from the butt end of body 51 toward the neck 55. The finger tabs 80, 82 are each connected to a pusher 88, 90. Each of the pushers 88, 90 is a lobular rod connected to it corresponding finger tab 80, 82 by a flange 92, 94. The flanges 92, 94 are eccentrically mounted to the rod-shaped pushers 88, 90, which are substantially cylindrical with an arcuate segment of the cylinder removed to form the lobular shape. The lobular shape of the pushers 88, 90 provides a close tolerance between the pusher and the upper portion of the cavities 60, 62, but leaves a small gap between the pushers 88, 90 and the lower portion of the cavities 60, 62 opposite the flanges 92, 94 so that the pushers 88, 90 ride over the scoops 104, 106, as described below.

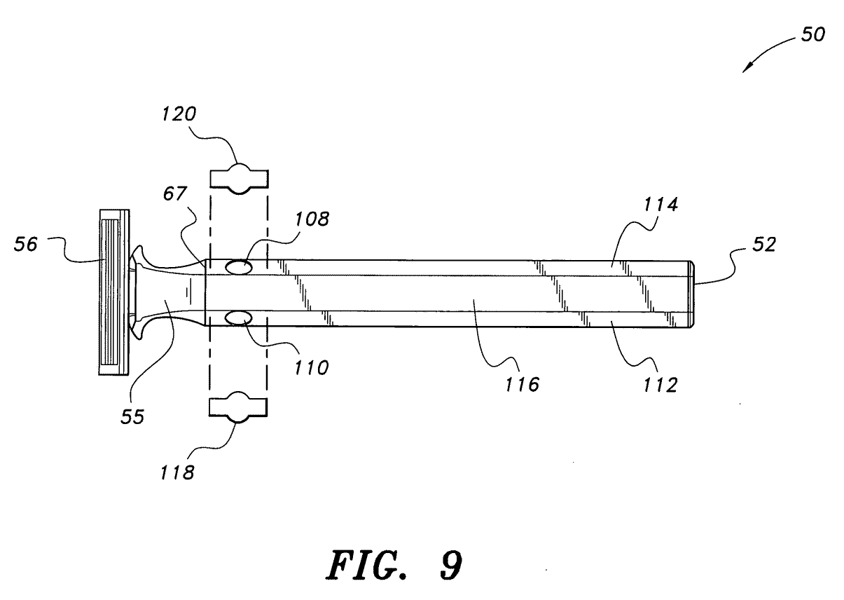

Prior to affixing the end cap 52 to the body 51, a pair of straw-shaped tubes 96. 98 are slide into cavities or channels 60, 62. The tubes 96, 98 hold the shaving lubricant and comprise permeable bladders. As discussed with the other embodiments, the shaving lubricant may be any type of shaving lubricant, such as, but not limited to, shaving creams, lathers, foams or gels. The tubes 96, 98 have flexible bellows or bending portions 100, 102 at one end and guides or scoops 104, 106 at the ends opposite the bellows 100, 102. The scoops 104, 106 facilitate movement of the respective pushers 88, 90, the pushers 88, 90 riding above the scoops 104, 106 to center the pushers 88, 90 behind each tube 96, 98 of lubricant. The bellows 100, 102 of each tube 96, 98 slide into the cavities 60, 62 and mate with corresponding dispensing holes 108, 110. The dispensing holes 108, 110 are made through the body 51 into the cavities 60, 62 near the neck 55 on the faces 112, 114 of body 51 that extend downward from the faces 72, 74 having the slider tracks 68, 70 defined therein, the bottom face 116 extending between faces 112, 114, as shown in FIG. 9.

Tab members 118, 120 are removably attached over each of the dispensing holes 108, 110 to seal the holes 108, 110 and keep the tubes 96, 98 holding the shaving lubricant airtight. To move or dispense shaving lubricant through one of the dispensing holes 108, 110, the corresponding tab member 118, 120 is removed. This unseals one of the dispensing holes 108, 110 that has received the bellows portion 100, 102 of the corresponding tube 96, 98. The bellows 100, 102 has a diameter that is slightly smaller than a diameter of the dispensing hole 108. 110, and is held there with a pressure fit in the dispensing hole 108, 110. The corresponding slider 76, 78 is moved forward toward the solid neck 55. The corresponding pusher 90, 92 moves over the respective scoop 104, 106, forming a bulldozing type of pushing mechanism and flattening the tube 96, 98, pushing the shaving lubricant by pressure out the respective dispensing hole 108, 110. The shaving lubricant is dispensed into the free hand of the shaver. From there, the shaving lubricant is applied to an area to be shaved in a manner consistent with how one would apply similar shaving lubricant.

The combo disposable razor and shaving lubricant dispenser 10, 50 makes the traditional “home” shave portable by providing both razor and the shaving lubricant 20 in one unit, thereby saving space and weight while traveling or at remote locations. The combo disposable razor and shaving lubricant dispenser 10, 50 easily fits in a shirt pocket or sleeve compartment in a purse or brief case, and includes everything but water for the shaving experience. The combo disposable razor and shaving lubricant dispenser 10, 50 obtains a “normal” shave while traveling or on the go without having to pack cartridge replacement blades or bulky cans of shaving material. The combo disposable razor and shaving lubricant dispenser 10, 50 additionally allows an opportunity to shave during travel, such as long flights, without having to rearrange carry-on-luggage or carry a shaving kit into an airline bathroom. The amount of the shaving lubricant 20 is also less than a stated amount of permissible liquids allowed on board by TSA. The combo disposable razor and shaving lubricant dispenser 10, 50 is ideal for traveling or outdoors sports, such as hunting and fishing, in remote locations. Also, hotels can use the combo disposable razor and shaving lubricant dispenser 10, 50 for those that may have forgotten to pack their shaving items. It is further contemplated that the combo disposable razor and shaving lubricant dispenser 10, 50 be made of biodegradable material, so that it is readily disposable for those situations where storage space is at a premium, such as on ships or other types of water vessels.

It is to be understood that the present invention is not limited to the embodiments described above, but encompasses any and all embodiments within the scope of the following claims.

I claim:

1. A combo disposable razor and shaving lubricant dispenser, comprising:
an elongated handle defining a cavity adapted for holding shaving lubricant, the handle having a butt end and a razor head end, the razor head end having an arcuate wall, the handle having a top side and a bottom side, the cavity extending from the butt end to the arcuate wall, the top side having a slider track, the bottom side having an opening near the arcuate wall adapted for dispensing the shaving lubricant from the cavity;
a pusher movably positioned in the cavity for pushing the shaving lubricant from the cavity out the opening in the bottom side;
a slider connected to the pusher, the slider being positioned on the top side of the handle over the slider track and outside the cavity, the slider being adapted for moving the pusher from the butt end towards the arcuate wall;
a ball movably positioned in the cavity between the pusher and the arcuate wall, the ball being adapted for moving the shaving lubricant from the cavity out the opening in the bottom side, the arcuate wall guiding the ball into the opening in the bottom side of the elongated rectangular body; and
a tab member attached to the opening in the bottom side of the handle for removal prior to movement of the slider and for exposing the opening in the bottom side during the dispensing of the shaving lubricant.

2. The combo disposable razor according to claim 1, further comprising a bladder adapted for holding the shaving lubricant, the bladder being positioned in the handle cavity.

3. The combo disposable razor according to claim 1, further comprising sealing material covering the slider track.

4. The combo disposable razor according to claim 1, further comprising a razor head attached to the razor head end of the handle, the razor head having at least one razor blade.

5. A combo disposable razor and shaving lubricant dispenser, comprising:
an elongated handle having a butt end and a head end, the handle having a pair of dispensing openings defined therein adjacent the head end, the handle defining a pair of elongated bores extending substantially from the butt end to the pair of openings adjacent the head end, the bores and openings defining independently operable shaving lubricant dispenser cavities, the handle having a pair of slider tracks defined therein extending into the bores;
a neck extending from the head end of the handle, the neck being a solid body having a razor head mount;
a razor head attached to the razor head mount, the razor head having at least one razor blade;
a pair of sliders, each of the sliders having a pusher body slidably disposed in a corresponding one of the bores, a flange extending from the pusher bodies through the corresponding slider tracks, and a finger tab attached to each of the flanges, respectively; and
a release tab removably disposed over the pair of openings in the handle.

6. The combo disposable razor according to claim 5, further comprising an end cap attached to the butt end of the handle.

7. The combo disposable razor according to claim 5, wherein said handle is hexagonal in transverse cross section, having a top face, a bottom face, two upper side faces extending from the top face, and two lower side faces extending from the bottom face, the slider tracks being defined in the upper sides faces, respectively, the two dispenser openings being defined in the two lower side faces, respectively.

8. The combo disposable razor according to claim 5, further comprising two elongated straw-shaped, tubular bladders adapted for holding the shaving lubricant, one of the bladders being disposed in one of the cavities and the other bladder being disposed in the other cavity, respectively, whereby either one of the lubricant bladders may be selectively and independently use to dispense the lubricant.

9. The combo disposable razor according to claim 8, wherein each of the bladders has one end defining a bellows, the bellows being flexible, the bellows end forming a friction fit with the corresponding dispenser opening.

10. The combo disposable razor according to claim 9, wherein each of the bladders has an end opposite the bladders, the end opposite the bladders having a scoop extending therefrom for guiding the corresponding slider pusher against the bladder.

11. The combo disposable razor according to claim 10, wherein each of the pusher bodies is a lobular rod, having a substantially cylindrical body having an arcuate segment removed therefrom, the pusher bodies closely approximating the respective cavities adjacent the slider tracks and having a gap between the pusher bodies and the cavities opposite the flange so that the pusher bodies ride over the scoops extending from the bladders.

12. The combo disposable razor according to claim 11, wherein each of the pusher bodies is eccentrically attached to the corresponding flange.

13. The combo disposable razor according to claim 5, wherein each of the slider finger tabs has raised ridges.
